(19) United States
(12) Patent Application Publication
(10) Pub. No.: US 2016/0047070 A1
(43) Pub. Date: Feb. 18, 2016

(54) FABRIC

(71) Applicant: ASUSTeK COMPUTER INC., Taipei City (TW)

(72) Inventors: Wen-Chang Hung, Taipei City (TW); Chia-Hsien Chang, Taipei City (TW)

(21) Appl. No.: 14/740,295

(22) Filed: Jun. 16, 2015

Related U.S. Application Data
(60) Provisional application No. 62/037,585, filed on Aug. 14, 2014.

(30) Foreign Application Priority Data
Apr. 22, 2015 (CN) 201510193321.2

(51) Int. Cl. D02G 3/34; D01F 8/04; D04B 21/08; D03D 1/00; F21V 9/16; D03D 15/00; D01F 1/10; D01F 8/18

(52) U.S. Cl. CPC D02G 3/346; D01F 1/10; D01F 8/04; D01F 8/18; D03D 1/0035; D03D 1/00; F21V 9/16; D03D 15/00; D04B 21/08; B82Y 20/00

(57) ABSTRACT

A fabric weaved at least by a first yarn and a second yarn is provided. A first quantum dot material is distributed in the first yarn, and a second quantum dot material is distributed in the second yarn. An average particle size of the first quantum dot material is different from the average particle size of the second quantum dot material.

### CROSS-REFERENCE TO RELATED APPLICATION

This application claims the priority benefit of U.S. provisional application Ser. No. 62/037,585, filed on Aug. 14, 2014 and China application serial No. 201510193321.2, filed on Apr. 22, 2015. The entirety of each of the above-mentioned patent applications is hereby incorporated by references herein and made a part of specification.

### BACKGROUND OF THE INVENTION

1. Field of the Invention

The invention relates to a fabric and, more particularly, relates to a photoluminescence fabric.

2. Description of the Related Art

Generally speaking, the quantum dots include Zinc (Zn), Cadmium (Cd), Selenium (Se) and Sulphur atoms. The energy level of the quantum dots relates to the size of the structure. Consequently, when the size of the quantum dots of the same material is changed, the color of the light may be different when the quantum dots are excited by an external light source. Consequently, the quantum dots can change the color of the external light source. Therefore, the quantum dots material is a wavelength conversion material.

The operating principle of the quantum dots and that of the yttrium-aluminum-garnet-based (YAG) fluorophore are similar, that is, with the excitation of the light emitting diode (LED), the quantum dots emits different combinations of colors, and white light is provided finally. In the same brightness, the quantum dots LED needs less blue light, thus, less power is needed in the electro-optic conversion, which is much power saving.

In the conventionally quantum dots technology, red quantum dots (the average particle size is about 10 nm) and the green quantum dots (the average particle size is about 5 nm) are mixed to a polymer and then coated to an optical film. However, the mixing time is long, and the quantum dot material with different average particle sizes cannot be uniformly distributed in a polymer solution after mixed. Consequently, the quantum dots are not uniform enough when the mixture is applied to the optical film. When the blue light or the ultraviolet light (UV-light) LED is continuously irradiated to an optical film, the luminous uniformity is poor.

### BRIEF SUMMARY OF THE INVENTION

A fabric is provided, and uniform light can be generated when the fabric is excited by light.

A fabric weaved at least by a first yarn and a second yarn is provided. A first quantum dot material is distributed in the first yarn, and a second quantum dot material is distributed in the second yarn. An average particle size of the first quantum dot material is different from the average particle size of the second quantum dot material.

In the fabric in embodiments, different average particle sizes of the quantum dot materials are distributed in different yarns. Different fabrics can be formed by weaving different yarns in different weaving methods. In contrast to the conventionally method, that is, different average particle sizes of the quantum dots are mixed to the polymer solution by a mixing method and then coated to an optical film, the method in embodiments is timesaving and easy to be mass produced. Furthermore, unlike conventional method that different average particle sizes of the quantum dots are not easily mixed, which results the uniform problem, in embodiments of the invention, the quantum dot materials is more uniform. The uniform light can be generated when the fabric is irradiated by an external light source.

### BRIEF DESCRIPTION OF THE DRAWINGS

These and other features, aspects and advantages of the invention will become better understood with regard to the following embodiments and accompanying drawings.

FIG. 1A to FIG. 1C shows a fabric in three embodiments of the invention;

FIG. 2 is a schematic diagram showing that a fabric is applied to a light guiding system in an embodiment;

FIG. 3A to FIG. 3G shows a fabric in another seven embodiments of the invention; and

FIG. 4 is a schematic diagram showing an electrospinning device for manufacturing a fabric in an embodiment.

### DETAILED DESCRIPTION OF THE EMBODIMENTS

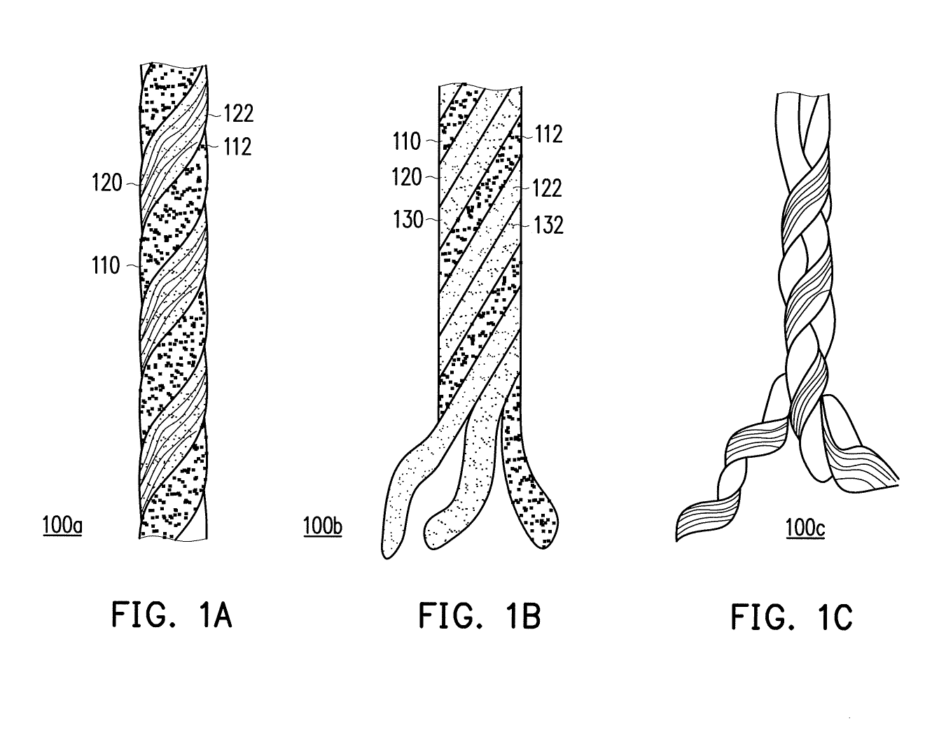

FIG. 1A shows a fabric in an embodiment of the invention. As shown in FIG. 1A, a fabric is a thread 100a. In the embodiment, the thread 100a is a two-fold yarn twisted by a first yarn 110 and a second yarn 120. A first quantum dot material 112 is distributed in the first yarn 110. A second quantum dot material 122 is distributed in the second yarn 120. An average particle size of the first quantum dot material 112 is different from the average particle size of the second quantum dot material 122. In the embodiment, the average particle size of the first quantum dot material 112 is between 6 nm to 10 nm, the average particle size of the second quantum dot material 122 is between 4 nm to 6 nm, which is not limited herein. The peak wave length of the first yarn 110 excited by the blue light or the UV-light is in the wavelength band of the red light, and the peak wave length of the second yarn 120 excited by the blue light or the UV-light is in the wavelength band of the green light.

In the following embodiments, the same or similar number denotes the same or the similar components or parts as in the above embodiment, and the similar description can be referred above and is omitted for a concise purpose.

In the embodiment, the thread is twisted by different knitting methods. The strength and elasticity are improved after twisted, then, a softer fabric can be provided, and the quantum dot materials are arranged more uniformly. As shown in FIG. 1B, the fabric is a multiplied yarn 100b. The multiplied yarn 100b is twisted by the first yarn 110, the second yarn 120 and the third yarn 130. A third quantum dot material 132 is distributed in the third yarn 130, and the average particle size of the third quantum dot material 132 is different from the average particle size of the first quantum dot material 112 and the average particle size of the second quantum dot material 122. In the embodiment, the average particle size of the third quantum dot material 130 is between 2 nm to 4 nm, which is not limited herein. In the embodiment, the peak wave length of the third yarn 130 excited by the blue light or the UV-light is in the wavelength band of the blue light. The weaving method of the first yarn 110, the second yarn 120 and the third yarn 130 also may be folded twist (as shown in FIG. 1C), which is not limited herein.

The yarn of the fabric in the above embodiments includes the first yarn 110, the second yarn 120 and the third yarn 130 according to the average particle size of the quantum dot material. The first yarn 110, the second yarn 120 and the third yarn 130 are weaved to form the fabric by different weaving methods to make the quantum dot materials uniformly. In contrast to the conventional mixing method, the mixing time is saved. Thus, the manufacture is simple, and the mass production is easy. Moreover, it also can solve the problems that the quantum dots with different average particle sizes are not easily to be mixed and the emitted light is not uniform. Then, the generated light is uniform when the fabric is irradiated by the blue light, the UV-light or other light sources.

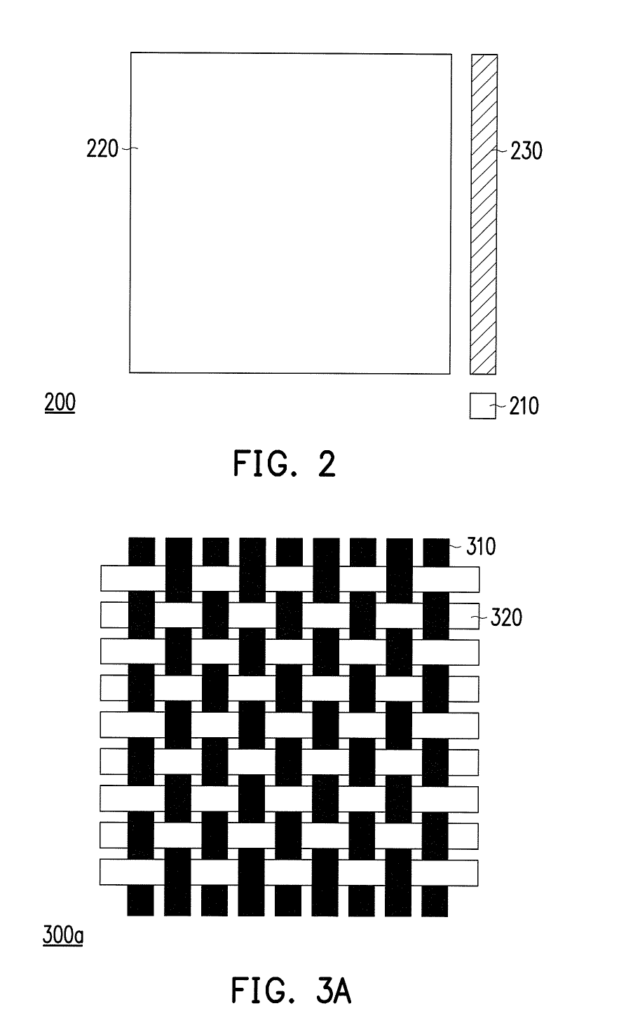

The fabric in embodiments can be applied at different industries. For example, the fabric can be implanted in the surgical site on a patient after a surgery. To observe the recovery of the surgical site, the fabric is excited to emit light when irradiated by the blue light or the UV-light, and thus the surgical site is tagged to notice medical persons during a follow-up period. The fabric also can be applied to a light guiding system. As shown in FIG. 2, a light guiding system 200 includes a light-emitting unit 210, a light panel 220 and a fabric 230. The fabric 230 is located at a side of the light panel 220. The light-emitting unit 210 is at one end of the fabric 230. In an embodiment, the fabric 230 is the thread 100a in the above embodiment, the thread 100a is weaved by the first yarn 110 with the first quantum dot material 112 and the second yarn 120 with the second quantum dot material 122. The average particle size of the first quantum dot material 112 is between 6 nm to 10 nm, and the average particle size of the second quantum dot material 122 is between 4 nm to 6 nm. In an embodiment, the light-emitting unit 210 is the blue light LED. That is, when the light-emitting unit 210 emits the blue light, the fabric 230 is excited by the blue light to emit the red light or the green light. Then, by mixing with the blue light of the light-emitting unit 210, a white light is formed. The white light is more uniform after the guiding of the light panel 220. Various kinds of light effects can be shown by changing the average particle size of the quantum dot materials in the fabric 230 and cooperating with the light-emitting unit 210 according to requirements.

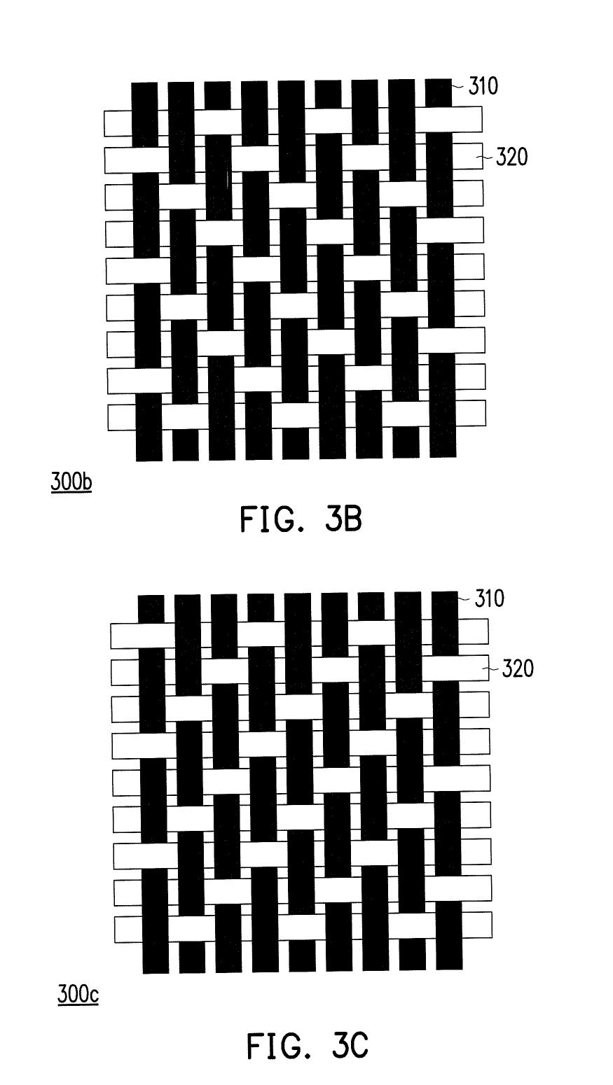

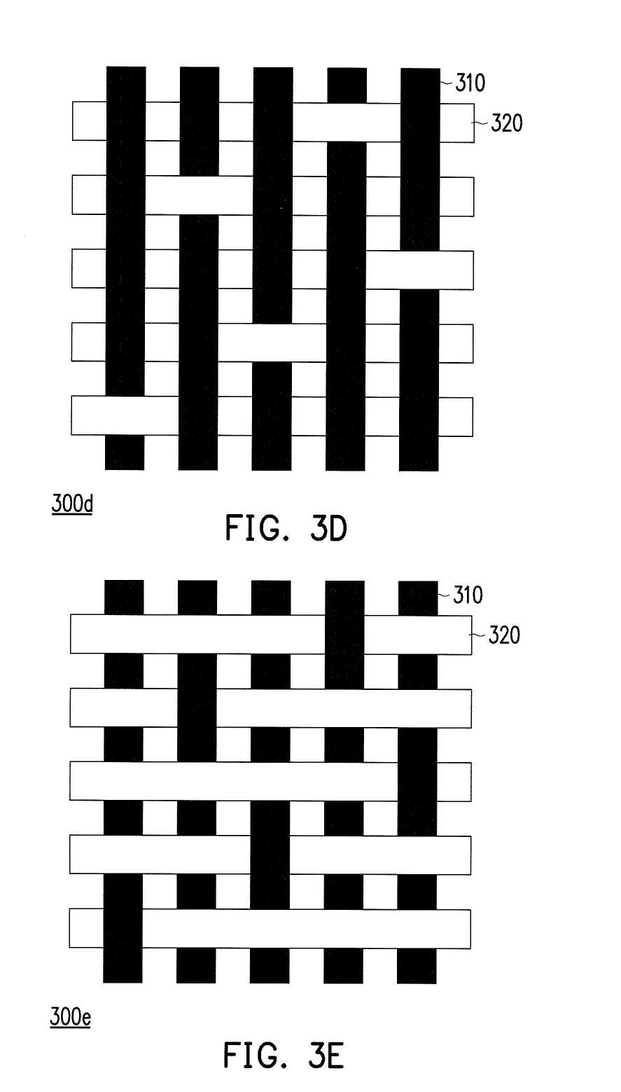

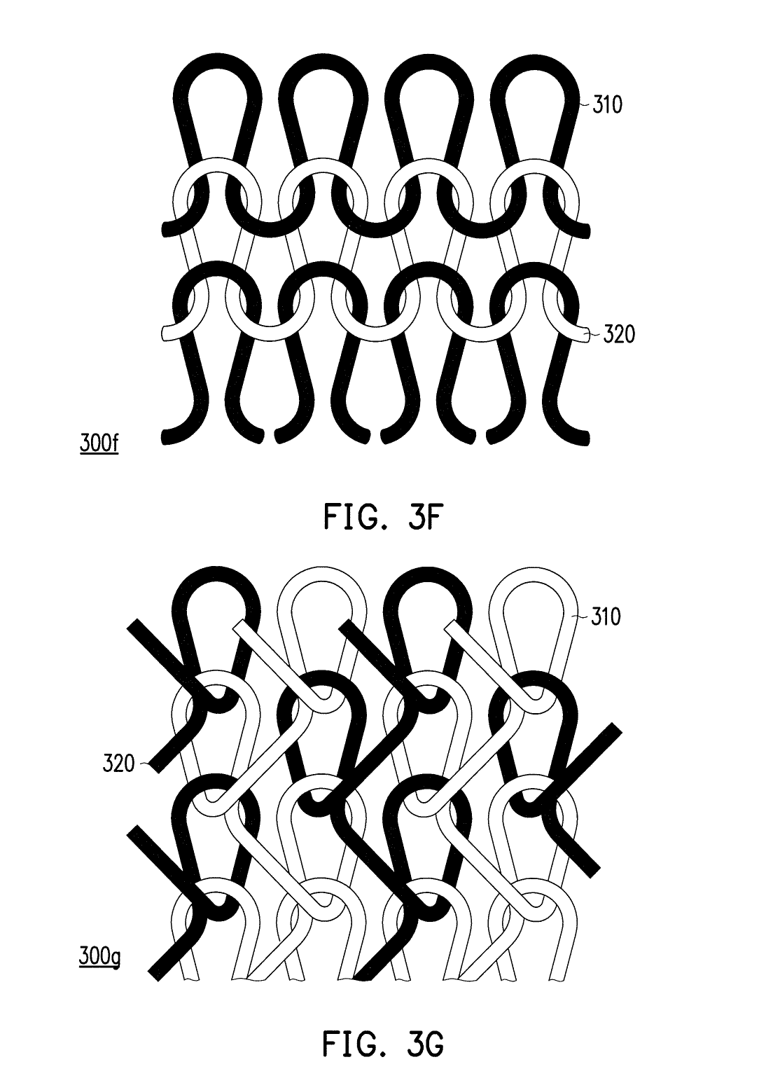

FIG. 3A shows a fabric in an embodiment of the invention. As shown in FIG. 3A, a fabric 300a is cloth, a first yarn 310 is the warp yarn of the cloth 300a, and a second yarn 320 is the weft yarn of the cloth 300a. In the embodiment, the cloth 300a is plain cloth. In other embodiments, the cloth has other weaving methods, such as twilled cloth (such as left twilled cloth shown in FIG. 3B and right twilled cloth shown in FIG. 3C), atlas tricot cloth (as shown in FIG. 3D), and weft satin (as shown in FIG. 3E), which is not limited herein.

FIG. 3F shows a fabric in an embodiment of the invention. As shown in FIG. 3F, in the embodiment, the fabric is cloth 300f. The cloth 300f is weft knitted cloth weaved alternately by the first yarn 310 and the second yarn 320. In other embodiments, the cloth has other weaving methods, for example, the cloth is warp knitted cloth shown in FIG. 3G, which is not limited herein.

In an embodiment, the thickness of the cloth is less than 500 nm, the cloth can be used at luminous cloth or a light guiding system to reduce the whole thickness. In detail, the cloth is weaved by the first yarn 310 with the first quantum dot material 312 and the second yarn 320 with the second quantum dot material 322. The average particle size of the first quantum dot material 312 is between 6 nm to 10 nm, and the average particle size of the second quantum dot material 222 is between 4 nm to 6 nm. The fabric generates red light and green light when excited by the blue light from the blue light LED, then, uniform white light is shown when the red light and the green light mix with the blue light from the blue light LED, as a result, luminous cloth is provided. Furthermore, according to requirements of users, different luminous effects can be got by changing the average particle size of quantum dot materials in the cloth and cooperating with a light source with different colors.

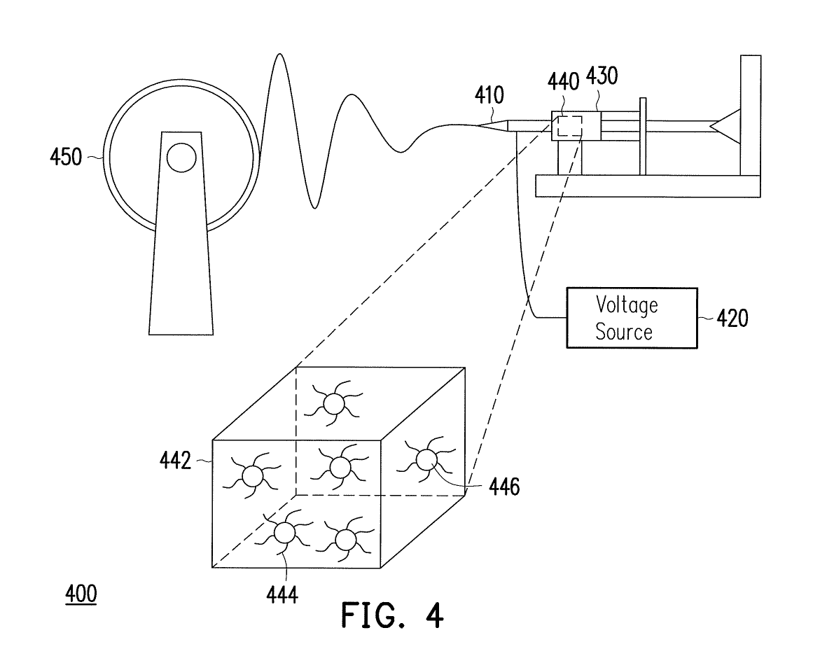

FIG. 4 is a schematic diagram showing an electrospinning device for manufacturing a fabric in an embodiment. As shown in FIG. 4, an electrospinning device 400 includes an electrospinning needle 410, a voltage source 420, a container 430, an electrospinning solution 440, and a yarn collection unit 450. The electrospinning solution 440 is held in the container 430. The voltage source 420 is electronically connected to the electrospinning needle 410. A voltage difference exists between the electrospinning needle 410 and the yarn collection unit 450 to make the electrospinning solution 440 output from the electrospinning needle 410, and spinning of the electrospinning solution 440 is collected by the yarn collection unit 450. The pinning can be cut according to the required length. The first yarn, the second yarn and the third yarn can be made according to the electronic spinning method in the embodiment, which is not limited herein. The diameter of the formed yarn is about 100 nm, which is not limited herein.

The electrospinning solution 440 includes a solvent 442, a surfactant 444 and a quantum dot material 446. The solvent 442 is a transparent optical polymer for separating external moisture and oxygen to avoid the reaction with the quantum dot material 446. The transparent optical polymer is polymethyl methacrylate (PMMA) or a Silicon material, which is not limited herein. A surfactant 444 covers the surface of the quantum dot material 446 to avoid the quantum dot materials 446 mix with each other. In an embodiment, the surfactant 444 is a fluorine containing surfactant. The quantum dot material 446 is a II-VI semiconductor compound, a III-V semiconductor compound, a IV-VI semiconductor compound or a IV semiconductor compound, which is not limited herein.

In an embodiment, the quantum dot material 446 is a II-VI semiconductor compound, such as CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe and HgZnSTe, which is not limited herein.

In an embodiment, the quantum dot material 446 is a III-V semiconductor compound, such as GaN, GaP, GaAs, GaSb, AN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs and InAlPSb, which is not limited herein.

In an embodiment, the quantum dot material 446 is a IV-VI semiconductor compound, such as SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe and SnPbSTe, which is not limited herein.

In an embodiment, the quantum dot material 446 is a IV semiconductor compound, such as Si, Ge, SiC and SiGe, which is not limited herein.

The first yarn, the second yarn, and the third yarn can be formed by adding different average particle sizes of the quantum dot material 446 into the electrospinning solution 440. The fabric can be got by weaving these yarns in above methods, which is not limited herein.

In sum, in the fabric, different average particle sizes of the quantum dot materials are distributed in different yarns, the different yarns are weaved uniformly to form the fabric, and then the quantum dot materials are distributed uniformly. In contrast to the conventionally method, that is, different average particle sizes of the quantum dots are mixed to the polymer by a mixing method, the method in embodiments is timesaving and easy to be mass produced. Furthermore, unlike conventional method that different average particle sizes of the quantum dots are not easily mixed which results the uniform problem, in embodiments of the invention, uniform light can be generated when the fabric is irradiated by the blue light, the UV-light, or other light sources.

Although the invention has been disclosed with reference to certain preferred embodiments thereof, the disclosure is not for limiting the scope. Persons having ordinary skill in the art may make various modifications and changes without departing from the spirit and the scope of the invention. Therefore, the scope of the appended claims should not be limited to the description of the preferred embodiments described above.

What is claimed is:

1. A fabric, including a first yarn and a second yarn, comprising:
a first yarn, wherein a first quantum dot material is distributed in the first yarn;
a second yarn, wherein a second quantum dot material is distributed in the second yarn;
wherein an average particle size of the first quantum dot material is different from the average particle size of the second quantum dot material.

2. The fabric according to claim 1, wherein the fabric is a thread.

3. The fabric according to claim 2, wherein the thread is a multiplied yarn.

4. The fabric according to claim 1, wherein the fabric is cloth.

5. The fabric according to claim 4, wherein the first yarn is a warp yarn of the cloth, the second yarn is a weft yarn of the cloth, and the cloth is plain cloth, twilled cloth, atlas tricot or weft satin.

6. The fabric according to claim 4, wherein the cloth is weft knitted cloth or warp knitted cloth weaved by the first yarn and the second yarn alternately.

7. The fabric according to claim 1, wherein the average particle size of the first quantum dot material is between 6 nanometers to 10 nanometers.

8. The fabric according to claim 1, wherein the average particle size of the second quantum dot material is between 4 nanometers to 6 nanometers.

9. The fabric according to claim 1, wherein the fabric further includes a third yarn, the fabric is weaved by the first yarn, the second yarn, and the third yarn, a third quantum dot material is distributed in the third yarn, the average particle size of the third quantum dot material is different from the average particle size of the first quantum dot material and the average particle size of the second quantum dot material.

10. The fabric according to claim 9, wherein the average particle size of the third quantum dot material is between 2 nanometers to 4 nanometers.
